(19) United States
(12) Patent Application Publication
(10) Pub. No.: US 2021/0121805 A1
(43) Pub. Date: Apr. 29, 2021

(54) DESORBER FOR AIR CONDITIONING SYSTEM HAVING INTEGRATED MICROEMULSION-BASED AIR DEHUMIDIFICATION

(71) Applicant: Carrier Corporation, Jupiter, FL (US)

(72) Inventors: Haralambos Cordatos, Colchester, CT (US); Zissis A. Dardas, Worcester, MA (US)

(21) Appl. No.: 16/635,689

(22) PCT Filed: Jul. 31, 2018
(86) PCT No.: PCT/US2018/044538

§ 371 Date: Jan. 31, 2020

Related U.S. Application Data
(60) Provisional application No. 62/539,206, filed on Jul. 31, 2017.

(51) Int. Cl. B01D 46/00; B01D 50/00

(52) U.S. Cl. CPC B01D 46/003; B01D 45/16; B01D 50/002

(57) ABSTRACT

Disclosed is a desorber (20) for an air conditioning system with an integrated microemulsion-based air dehumidification system, the desorber having: a desorbing sheet that is wound to form an exterior end (21), an interior end (22), a top end and bottom end, wherein a collection tube (23) is disposed at the interior end and the desorbing sheet has: a plurality of de-entrainment mesh layers extending between the exterior end and the interior end of the desorbing sheet, and a plurality of substantially air impermeable connector layers extending between the exterior end and the interior end of the desorbing sheet, wherein the connector layers are interlaid with the mesh layers between the top end and the bottom end of the desorbing sheet.

### BACKGROUND

Exemplary embodiments pertain to the art of desorbing systems and more specifically to a desorber for an air conditioning system having integrated microemulsion-based air dehumidification.

One type of air conditioning system is a heating ventilation air conditioning (HVAC) system with an integrated microemulsion-based air dehumidification system is a technology that may provide latent air cooling while enhancing system performance. A microemulsion-based air dehumidification system may present an efficient and cost-effective alternative to dehumidification technologies involving corrosive liquid desiccant solutions (LiCl, LiBr) and desiccant wheels. A microemulsion-based air dehumidification system may be enabled by organic liquid-based microemulsion sorbents which may provide the following relative benefits: 1) heat required for microemulsion organic liquid regeneration e.g. via a microemulsion-based desorber may be a fraction of that required when using other desiccants; 2) desiccant regeneration temperature may be comparably low; 3) when heat is supplied, absorbed fluids may be released as liquid rather than vapor thereby reducing the need for certain condensers while desorbed fluids may be used to cool other condensers; and 4) the utilized organic solutions are not corrosive thereby reducing operational complexity and cost.

In view of the benefits of an HVAC system using a microemulsion-based air dehumidification system, there is a desire to address oil carryover downstream of a microemulsion-based desorber. Two categories of oil carryover include: (1) carryover in a form of an aerosol (liquid droplets); and (2) carryover in a form of a vapor. Oil droplets may occur from airflow velocity profiles created by geometrical features of oil wetted surfaces. Oil vapor may occur from temperature of the process vis-à-vis the oil vapor pressure. Typical processes for capturing oil aerosols may involve impacting and coalescing oil droplets onto a high surface area organic or metal fiber mesh. Processes for capturing oil vapors may involve refrigeration or/and adsorption of the oil vapor using a high-capacity solid sorbent.

Industrial devices may experience oil carryover issues including for example oil-lubricated rotary screw air compressors. Devices that address oil carryover may be designed for systems which produce large quantities of oil carryover compared with an HVAC system and may be designed for continuous removal of captured oil droplets, which can result in energy waste. FIGS. 1A and 1B illustrate known industrial desorbers 10a, 10b having automated drains. Such systems may be very complex and costly. In addition, such systems may be designed for operations that involve relatively high pressures providing oversized components that allow for an undesirably high pressure drop.

### BRIEF DESCRIPTION

Disclosed is a desorber for an air conditioning system with an integrated microemulsion-based air dehumidification system, the desorber comprising: a desorbing sheet that is wound to form an exterior end, an interior end, a top end and bottom end, wherein a collection tube is disposed at the interior end and the desorbing sheet comprises: a plurality of de-entrainment mesh layers extending between the exterior end and the interior end of the desorbing sheet, and a plurality of substantially air impermeable connector layers extending between the exterior end and the interior end of the desorbing sheet, wherein the connector layers are interlaid with the mesh layers between the top end and the bottom end of the desorbing sheet.

In addition to one or more of the features described above, or as an alternative, further embodiments may include that the connector layers are interlaid with the mesh layers the in a stripe pattern.

In addition to one or more of the features described above, or as an alternative, further embodiments may include that the desorbing sheet is spirally wound.

In addition to one or more of the features described above, or as an alternative, further embodiments may include that a radially center collection tube.

In addition to one or more of the features described above, or as an alternative, further embodiments may include the collection tube comprises an inner vapor filter and/or the desorbing sheet is wrapped in an outer vapor filter.

In addition to one or more of the features described above, or as an alternative, further embodiments may include that each vapor filter is an activated carbon filter.

In addition to one or more of the features described above, or as an alternative, further embodiments may include that top and bottom layers of the desorbing sheet are connector layers.

In addition to one or more of the features described above, or as an alternative, further embodiments may include that the mesh layers and/or connector layers are substantially dimensionally alike.

Further disclosed is an air conditioning system with an integrated microemulsion-based air dehumidification system, the microemulsion-based air dehumidification system including a desorber having one or more of the above features. Additionally disclosed is a method of desorbing oil from oil impregnated air in an air conditioning system with integrated microemulsion-based air dehumidification system, the method comprising: channeling the air into a desorber, the desorber having one or more of the above features.

### BRIEF DESCRIPTION OF THE DRAWINGS

The following descriptions should not be considered limiting in any way. With reference to the accompanying drawings, like elements are numbered alike:

FIGS. 1A and 1B illustrate known automated drains installed in industrial oil carryover capture systems;

FIG. 2 illustrates a known centrifugal separator;

FIGS. 3A and 3B illustrates a known demister;

FIG. 4 illustrates a known coalescing filter;

FIGS. 5A and 5B illustrate a desorber according to a disclosed embodiment; and

FIG. 6 illustrates a known vapor filter.

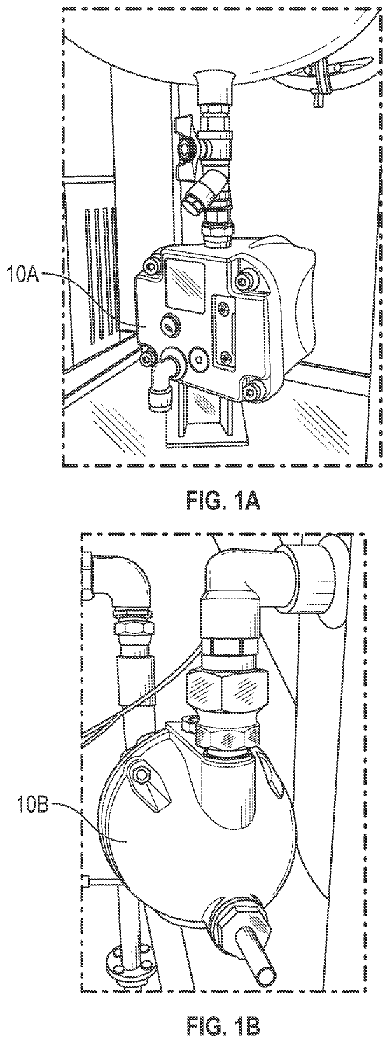

### DETAILED DESCRIPTION

A detailed description of one or more embodiments of the disclosed apparatus and method are presented herein by way of exemplification and not limitation with reference to the Figures.

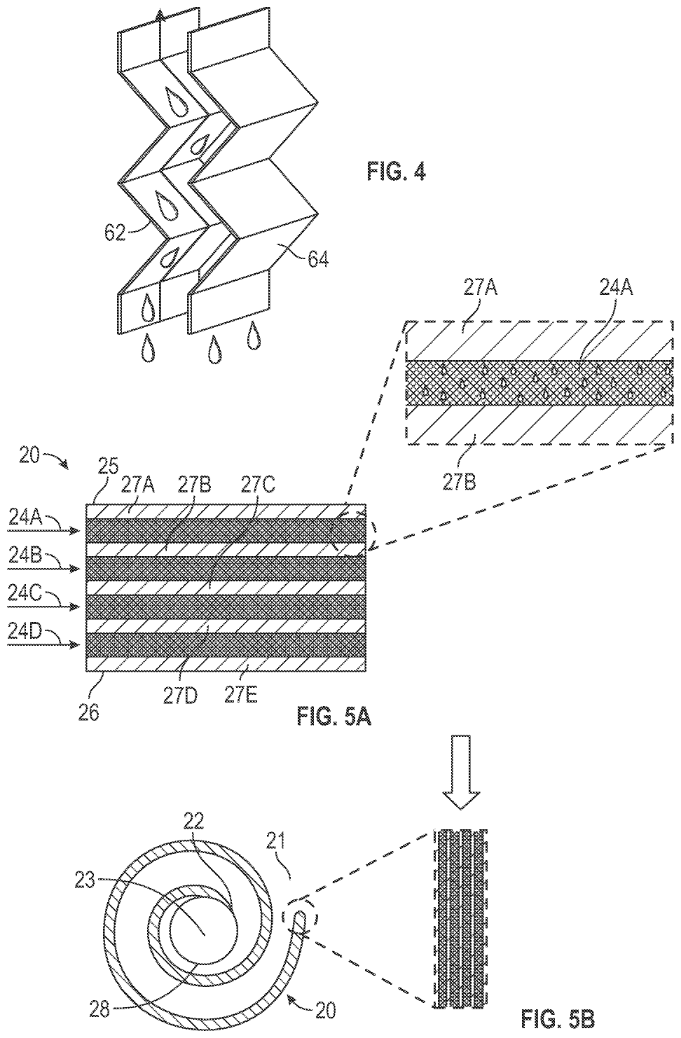

FIGS. 5A-5B illustrate a desorber 20, according to an embodiment for a microemulsion-based dehumidification system that is part of an air conditioning system, e.g., a heating venting air conditioning (HVAC) system and/or a refrigeration system. The desorber 20 may provide advantages typically found in a more complex system. The desorber 20 may be in the form of a replaceable module or cartridge, have a relatively small footprint and provide a relatively low pressure drop.

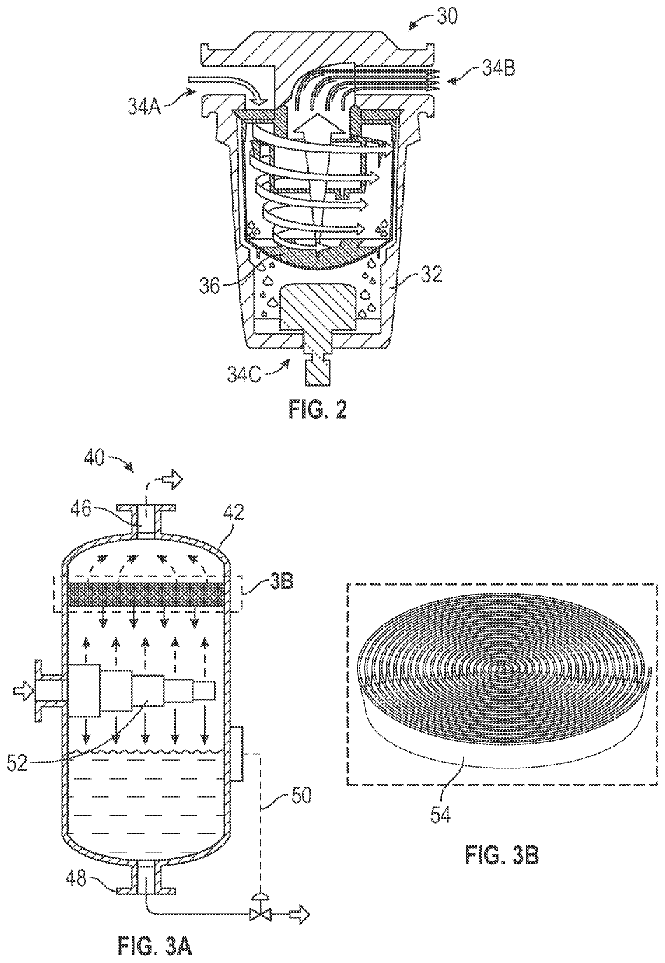

Referring now to FIGS. 2, 5A and 5B, the desorber 20 may minimize aerosol concentration of oil in part by functioning as a centrifugal separator 30. The centrifugal separator 30 may include a housing 32 with a plurality of openings, including first opening 34a, second opening 34b and third opening 34c. The first opening 34a functions as an inlet for oil impregnated air, and the second opening 34b functions as an outlet for partially desorbed air. The third opening 34c functions as a drain for oil collected in the separator 30. A centrifugal separator 30 forces incoming air into a spiral flow, which drives the larger and heavier droplets toward the walls of the housing 32 to be separated out by gravity.

Similarly, as illustrated in FIG. 5B, the disclosed desorber 20 has a spiral wound configuration, e.g., in a top view thereof, to form a centrifugal separator. The spiral curve of the desorber 20 is illustrated as planar and more specifically as an Archimedean spiral or involute of a circle. Other two dimensional spirals and three dimensional spirals may be applicable. Oil impregnated airflow enters in the outer radial segment 21 of the desorber 20 and speeds up while traveling to the center 22 of the desorber 20 into an oil collection tube 23. Larger, heavier droplets are centrifugally driven outward.

Referring now to FIGS. 3A, 3B, 5A and 5B, smaller aerosol particles in oil impregnated air may not be removed with centrifugal motion because smaller particles follow air streamlines. A known centrifugal separator 30 may therefore be fluidly followed by a known demister 40. The demister 40 includes a demister housing 42, a demister inlet 44a carrying oil impregnated air, a demister vapor outlet 46 carrying oil vapor demisted from the oil impregnated air, a demisted air outlet 48 carrying demisted air. The demister 40 may also include a pressure release loop 50 fluidly connected to the demisted air outlet 48. Internally, the demister 40 may contain a diffuser 52 and one or more mesh pads 54, illustrated in greater detail in FIG. 3B. The mesh pads 54 capture smaller oil droplets by impaction.

Similarly, the disclosed embodiment in FIGS. 5A and 5B may provide a plurality of layers of de-entrainment mesh material, including layers 24a-24d. The mesh layers 24a-24b may be spaced along a top-down direction for the desorber 20, i.e., from the top end 25 of the desorber 20 to the bottom end 26 of the desorber 20. The mesh layers 24a-24d may extend along the direction of airflow, so that each layer is extends between the radial outside of the desorber 21 and the radial inside of the desorber 22. The top-down span or height of the layers of mesh material 24a-24d are illustrated as each being substantially the same, though this is not a requirement. The area of each of the mesh layers 24a-24d, and the area summation of the layers, may be sufficient to demist air traveling through the desorber 20. The mesh layers 24a-24d may be plastic.

Turning now to FIGS. 4, 5A and 5B, the impregnated air in a known desorber may pass over coalescing membranes 62, 64. The membranes 62, 64 may coalesce remaining oil droplets into larger drops, which drain by gravity. In the disclosed embodiment, illustrated in FIGS. 5A and 5B, as impregnated air travels through the desorber 20, the shape of the mesh layers 24a-24d provides a large area for impaction and oil droplets coalesce as oil collides with the mesh surfaces and eventually drains downwards. For less demanding applications, such as with microemulsion-based dehumidification systems, the flow path could include a helically shaped desorber providing a continuous change of directional flow. Such shape can obtained with a 3D curve (not illustrated) rather than a spiral 2D curve.

A plurality of connector layers 27a-27e are interlaid with the mesh layers 24a-24d between the top end and the bottom end of the desorbing sheet. The connector layers 27a-27e are substantially air impermeable and extend between the internal end 21 and the internal end 22 of the desorber 20. The plurality of connector layers 27a-27e are, e.g., plastic. Other spacer material may be utilized for the connector layers.

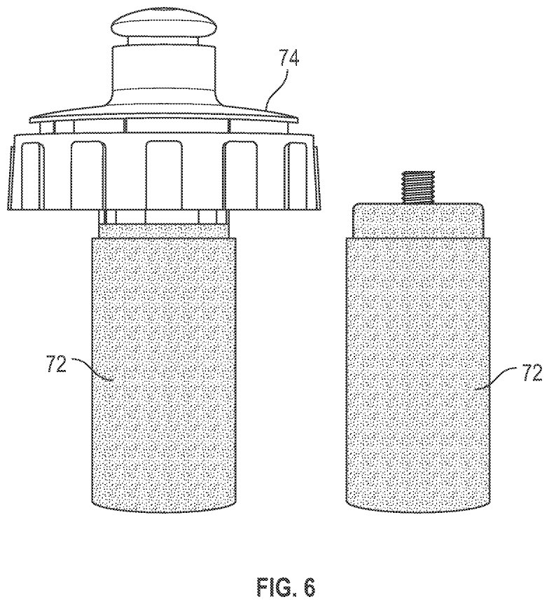

Turning now to FIGS. 5A, 5B and 6, an outer filter 72 may be used as a fourth desorbing element for processes where oil vapors in addition to oil aerosols are not tolerated. In a known desorbing system a refrigerant dryer (not illustrated) may be utilized or an activated carbon cartridge such as found within certain drinking bottles 74 may be wrapped around the desorber 20 to form the outer filter 72. Similarly, the disclosed embodiment may provide an inner vapor filter which is an active carbon filter cartridge 28 at the inner radius 22 of the desorber 20. The specific diameter and length of the active carbon cartridge 28 may be sufficient to provide desired filtering of oil vapor in air traveling therethrough.

For microemulsion-based dehumidification systems, the use of four separate devices described above results in excessive cost and pressure drop. The above disclosed desorber 20 may provide a relatively compact system designed to accomplish the same goal of more complex systems by combining the actions of centrifugal motion, impaction and coalescing.

In sum as illustrated in FIG. 5B the packaging of the desorber 20 may be a spiral-wound sheet. The desorber 20 comprises one or more membrane envelopes, wrapped around the central oil collection tube 23, and the tube 23 may surrounded by the active carbon cartridge 28. The permeating air travels toward the oil collection tube 23 along the spiral path with minimum pressure drop.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A desorber for an air conditioning system with an integrated microemulsion-based air dehumidification system, the desorber comprising:
a desorbing sheet that is wound to form an exterior end, an interior end, a top end and bottom end, wherein a collection tube is disposed at the interior end and the desorbing sheet comprises:
a plurality of de-entrainment mesh layers extending between the exterior end and the interior end of the desorbing sheet, and a plurality of substantially air impermeable connector layers extending between the exterior end and the interior end of the desorbing sheet, wherein the connector layers are interlaid with the mesh layers between the top end and the bottom end of the desorbing sheet.

2. The desorber of claim 1 wherein the connector layers are interlaid with the mesh layers the in a stripe pattern.

3. The desorber of claim 2 wherein the desorbing sheet is spirally wound.

4. The desorber of claim 3 further comprising a radially center collection tube.

5. The desorber of claim 4 wherein the collection tube comprises an inner vapor filter and/or the desorbing sheet is wrapped in an outer vapor filter.

6. The desorber of claim 5 wherein each vapor filter is an activated carbon filter.

7. The desorber of claim 6 wherein top and bottom layers of the desorbing sheet are connector layers.

8. The desorber of claim 7 wherein the mesh layers and/or connector layers are substantially dimensionally alike.

9. An air conditioning system with an integrated microemulsion-based air dehumidification system, the microemulsion-based air dehumidification system including a desorber, the desorber comprising: a desorbing sheet that is wound to form an exterior end, an interior end, a top end and bottom end, wherein a collection tube is disposed at the interior end and the desorbing sheet comprises:
a plurality of de-entrainment mesh layers extending between the exterior end and the interior end of the desorbing sheet, and a plurality of substantially air impermeable connector layers extending between the exterior end and the interior end of the desorbing sheet, wherein the connector layers are interlaid with the mesh layers between the top end and the bottom end of the desorbing sheet.

10. The system of claim 9 wherein the connector layers are interlaid with the mesh layers the in a stripe pattern.

11. The system of claim 10 wherein the desorbing sheet is spirally wound.

12. The system of claim 11 further comprising a radially center collection tube.

13. The system of claim 12 wherein the collection tube comprises an inner vapor filter and/or the desorbing sheet is wrapped in an outer vapor filter.

14. The system of claim 12 wherein the desorbing sheet is wrapped in an outer vapor filter.

15. The system of claim 13 wherein each vapor filter is an activated carbon filter.

16. The system of claim 15 wherein top and bottom layers of the desorbing sheet are connector layers.

17. The system of claim 16 wherein the mesh layers and/or connector layers are substantially dimensionally alike.

18. A method of desorbing oil from oil impregnated air in an air conditioning system with integrated microemulsion-based air dehumidification system, the method comprising:
channeling the air into a desorber having a desorbing sheet, the desorbing sheet wound to form an exterior end and an interior end, a top end and a bottom end, the collection tube connected to the interior end, and the desorbing sheet comprising:
a plurality of de-entrainment mesh layers extending between the exterior end and the interior end of the desorbing sheet, and a plurality of substantially air impermeable connector layers extending between the exterior end and the interior end of the desorbing sheet, wherein the connector layers are interlaid with the mesh layers between the top end and the bottom end of the desorbing sheet.

19. The method of claim 18 wherein the connector layers are interlaid with the mesh layers the in a stripe pattern.

20. The method of claim 19 wherein the desorbing sheet is spirally wound.
